(19) United States
(12) Patent Application Publication
(10) Pub. No.: US 2022/0270614 A1
(43) Pub. Date: Aug. 25, 2022

(54) SPEAKER EMBEDDING APPARATUS AND METHOD

(71) Applicant: NEC Corporation, Minato-ku, Tokyo (JP)

(72) Inventors: Kong Aik LEE, Tokyo (JP); Takafumi KOSHINAKA, Tokyo (JP)

(73) Assignee: NEC Corporation, Minato-ku, Tokyo (JP)

(21) Appl. No.: 17/625,155

(22) PCT Filed: Jul. 10, 2019
(86) PCT No.: PCT/JP2019/027304

§ 371 Date: Jan. 6, 2022

(51) Int. Cl. G10L 17/08; G10L 17/02; G10L 17/04

(52) U.S. Cl. CPC G10L 17/08; G10L 17/02; G10L 17/04

(57) ABSTRACT

An input unit 81 inputs an observation at current time step. A frame alignment unit 82 computes a frame alignment at a current time step by using the input observation. An i-vector computation unit 83 computes an i-vector and a precision matrix by using the computed frame alignment, the input observation, and a product obtained when computing the i-vector at the previous time step. An output unit 84 outputs the computed i-vector and precision matrix.

### TECHNICAL FIELD

The present invention relates to a speaker embedding apparatus, speaker embedding method, and non-transitory computer readable recording medium storing a speaker embedding program for real-time continuous speaker embedding.

### BACKGROUND ART

State-of-the-art speaker recognition systems consist of a speaker embedding front-end followed by a scoring backend. Two common forms of speaker embedding are i-vector and x-vector. For scoring backend, probabilistic linear discrimination analysis (PLDA) is commonly used.

Non Patent Literature 1 discloses the i-vector. The i-vector is a fixed-length low-dimensional representation of variable-length speech utterance. Mathematically, it is defined as the posterior mean of a latent variable in a multi-Gaussian factor analyzer. That is, the i-vector is given by the posterior mean (and covariance) of the continuous-value latent variable in a multi-Gaussian factor analyzer.

In addition, Non Patent Literature 2 discloses a method for computing the i-vector rapidly. The method disclosed in Non Patent Literature 2 reduces significantly the computational complexity of i-vector extraction with slight loses in performance.

### CITATION LIST

### Non Patent Literature

### [NPL 1]

N. Dehak, P. Kenny, R. Dehak, P. Dumouchel, and P. Ouellet, “Front-end factor analysis for speaker verification,” IEEE Transactions on Audio, Speech and Language Processing, vol. 19, no. 4, pp. 788-798, 2010.

### [NPL 2]

L. Xu, K. A. Lee, H. Li, and Z. Yang, “Generalizing i-vector estimation for rapid speaker recognition,” IEEE/ACM Transactions on Audio, Speech and Language Processing, vol. 26, no. 4, pp. 749-759, January 2018.

### SUMMARY OF INVENTION

### Technical Problem

It is assumed that a general i-vector as disclosed in Non Patent Literature 1 is used offline. FIG. 9 is an exemplary explanatory illustrating a general extraction example of the i-vector.

In the following explanation, when using a Greek letter in the text, an English notation of Greek letter may be enclosed in brackets ([ ]). In addition, when representing an upper case Greek letter, the beginning of the word in [ ] is indicated by capital letters, and when representing lower case Greek letters, the beginning of the word in [ ] is indicated by lower case letters.

C, [omega]_{C}, [mu]_{C}, [Sigma]_{C}, and T_{C} are parameters. C is a number of Gaussian components. [omega]_{C} is weights of the c-th Gaussian. [mu]_{C} is a mean vector of the c-th Gaussian. [Sigma] c is a covariance matrix of the c-th Gaussian. T_{C} is a total variability matrix of the c-th Gaussian.

Also, observation oₜ represents a feature vector of D dimensions at the time step t, and [tau] represents the number of feature vectors in a set or sequence of the observations.

The i-vector at time step [tau] can be computed by repeating the same step at each time step t. First, at time step t=1, the frame alignment [gamma]_{c, t} for each Gaussian component is computed based on the above-described parameters and an observation {o₁}. The frame alignment is computed by, for example, Equation 1 shown below.

$$\begin{matrix}[ Math . 1 ] & \\ {γ}_{c , t} = \frac{{ω}_{c} N ( {o}_{t} \vert {μ}_{c} , {Σ}_{c} )}{{\sum }_{l = 1}^{C} {ω}_{l} N ( {o}_{t} \vert {μ}_{l} , {Σ}_{l} )} for t = 1 , 2 , … , τ \\ N ( {o}_{t} \vert {μ}_{c} , {Σ}_{c} ) = \frac{1}{\sqrt{{( 2 π )}^{D} \vert {Σ}_{c} \vert}} exp [ - \frac{1}{2} {( {o}_{t} - {μ}_{c} )}^{T} {Σ}_{c}^{- 1} ( {o}_{t} - {μ}_{c} ) ] & ( Equation 1 )\end{matrix}$$

As a result of the computation, {oₜ, [gamma]_{c, t}: t=1} is computed. Next, accumulation processing of zero-order statistics and first-order statistics so far is performed. The zero-order statistic N_{C} and the first-order statistic F_{C} are computed by, for example, Equations 2 and 3 described below.

[Math. 2]

N_{c}=Σₜ₌₁^{τ}γ_{c,t} (Equation 2)

F_{c}=Σₜ₌₁^{τ}γ_{c,t}(oₜ−μ_{c}) (Equation 3)

Based on these pieces of information (zero-order statistics and first-order statistics), an i-vector is inferred. In general, precision matrix L and i-vector [phi] are computed using Equations 4 and 5 described below.

[Math. 3]

ϕ_{τ}=L_{τ}⁻¹[Σ_{c=1}^{C}T_{c}^{T}Σ_{c}⁻¹F_{c}] (Equation 4)

L_{τ}=[Σ_{c=1}^{C}N_{c}T_{c}^{T}Σ_{c}⁻¹T_{c}+I] (Equation 5)

Next, at time step t=2, the frame alignment is computed based on the above-described parameters and observations {o₁, o₂}. That is, the frame alignment is computed including the observation o₁ used in the past. Finally, using the observations {o₁, o₂, . . . , oₜ, . . . , o_{[tau]}}, the precision matrix L_{[tau]} and the i-vector [phi]_{[tau]} are computed.

On the other hand, in a situation where real-time continuous authentication is necessary, it is desirable that the i-vector can be updated in real time. As illustrated in FIG. 9, the general method assumes that all feature vectors, from o₁ to o_{[tau]}, are available to compute a single i-vector [phi] and its covariance matrix L⁻¹. That is, in order to estimate the i-vector, it is necessary to store all the raw features (entire speech segment). However, holding all speech is not realistic in terms of storage capacity.

Also, the method disclosed in Non Patent Literature 2 provides fast estimation of i-vector. That is, the method disclosed in Non Patent Literature 2 operates in off-line batch mode similar to the general i-vector as disclosed in Non Patent Literature 1, and does not assume updating in real time. Therefore, it is desirable to be able to realize speaker embedding in real time by being able to estimate the i-vector in real time.

It is an exemplary object of the present invention to provide speaker embedding apparatus, speaker embedding method, and non-transitory computer readable recording medium storing a speaker embedding program that can realize speaker embedding in real time while reducing the storage capacity.

### Solution to Problem

A speaker embedding apparatus using an i-vector including: an input unit which inputs an observation at current time step; a frame alignment unit which computes a frame alignment at a current time step by using the input observation; an i-vector computation unit which computes an i-vector and a precision matrix by using the computed frame alignment, the input observation, and a product obtained when computing the i-vector at the previous time step; and an output unit which outputs the computed i-vector and precision matrix.

A speaker embedding method using an i-vector comprising: inputting an observation at current time step; computing a frame alignment at a current time step by using the input observation; computing an i-vector and a precision matrix by using the computed frame alignment, the input observation, and a product obtained when computing the i-vector at the previous time step; and outputting the computed i-vector and precision matrix.

A non-transitory computer readable recording medium storing a speaker embedding program using an i-vector, when executed by a processor, that performs a method for: inputting an observation at current time step; computing a frame alignment at a current time step by using the input observation; computing an i-vector and a precision matrix by using the computed frame alignment, the input observation, and a product obtained when computing the i-vector at the previous time step; and outputting the computed i-vector and precision matrix.

### Advantageous Effects of Invention

According to the present invention, it is possible to realize speaker embedding in real time while reducing the storage capacity.

### BRIEF DESCRIPTION OF DRAWINGS

FIG. 1 It depicts an exemplary block diagram illustrating the structure of the first exemplary embodiment of a speaker embedding apparatus according to the present invention.

FIG. 2 It depicts an exemplary explanatory diagram illustrating the process of first exemplary embodiment of the speaker embedding apparatus according to the present invention.

FIG. 3 It depicts a flowchart illustrating the process of first exemplary embodiment of the speaker embedding apparatus according to the present invention.

FIG. 4 It depicts an exemplary block diagram illustrating the structure of the second exemplary embodiment of a speaker embedding apparatus according to the present invention.

FIG. 5 It depicts an exemplary explanatory diagram illustrating the process of second exemplary embodiment of the speaker embedding apparatus according to the present invention.

FIG. 6 It depicts a flowchart illustrating the process of second exemplary embodiment of the speaker embedding apparatus according to the present invention.

FIG. 7 It depicts a block diagram illustrating an outline of the speaker embedding apparatus according to the present invention.

FIG. 8 It depicts a schematic block diagram illustrating the configuration example of the computer according to the exemplary embodiment of the present invention.

FIG. 9 It depicts an exemplary explanatory illustrating a general extraction example of the i-vector.

### DESCRIPTION OF EMBODIMENTS

The following describes an exemplary embodiment of the present invention with reference to drawings. In the present invention, when new observation is given, products obtained at the time step of computation of the i-vector are recursively and continuously updated so that raw data (feature vectors) need not be held. The products are the i-vectors themselves or intermediate representations. Examples of intermediate representation include statistics such as zero-order statistics and first-order statistics.

In the present invention, since it is not necessary to keep raw data, it is possible to reduce the storage capacity. Also, since i-vector provides a highest level of abstraction compared to acoustical features and has a better irreversible properties, it is also possible to meet the requirement of data privacy. Also, according to the present invention, an exact solution can be obtained instead of an approximate solution as compared with a general offline i-vector.

### First Exemplary Embodiment

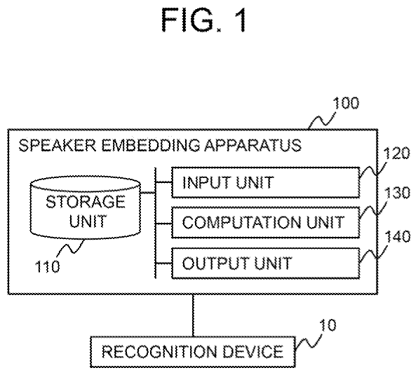

In the first exemplary embodiment, a method of performing speaker embedding by recursively updating the i-vector will be described. FIG. 1 depicts an exemplary block diagram illustrating the structure of a first exemplary embodiment of a speaker embedding apparatus according to the present invention. The speaker embedding apparatus 100 according to the present exemplary embodiment includes a storage unit 110, an input unit 120, a computation unit 130 and an output unit 140.

The speaker embedding apparatus 100 is connected to a recognition device 10, and the recognition device 10 performs speaker recognition (verification) using the processing result by the speaker embedding apparatus 100. Therefore, a system including the speaker embedding apparatus 100 of the present exemplary embodiment and the recognition unit 10 can be referred to as a speaker recognition system (speaker verification system).

The storage unit 110 stores the computation result by the computation unit 130 described later. In addition, the storage unit 110 may store observations input by the input unit 120 described later. Note that the speaker embedding apparatus 100 according to the present exemplary embodiment updates the i-vector at the current time step using the products obtained at the time step of computation of the previous i-vector. Therefore, the speaker embedding apparatus 100 does not have to store all the past observations. The storage unit 110 also stores various parameters used for computation by the computation unit 130 described later. The storage unit 110 is realized by, for example, a magnetic disk or the like.

The input unit 120 receives an input of observations used by the computation unit 130 described later for updating the i-vector. Specifically, the input unit 120 receives the observation oₜ at the current time step t. The input unit 120 may also receive input of various parameters used for computation by the computation unit 130 described later.

The computation unit 130 updates the i-vector using the observation oₜ at the current time step t and the products obtained at the time step of computation of the i-vector at the previous time step t−1. In this exemplary embodiment, the computation unit 130 uses the observation oₜ at the current time step t and the i-vector [phi]ₜ₋₁ and its precision matrix Lₜ₋₁ at the previous time step t−1 to compute the i-vector [phi]ₜ and precision matrix Lₜ.

Specifically, first, the computation unit 130 computes an alignment [gamma]_{C, t} of the feature vector oₜ to each of the C Gaussian components. In the Gaussian Mixture Model—universal background model (GMM-UBM) approach, [gamma]_{C, t} can be said to be the posterior probability that the feature vector oₜ is generated from the c-th element distribution of UBM. The computation unit 130 may computate the alignment [gamma]_{C, t} according to Equation 1 described above.

Next, the computation unit 130 computes the i-vector [phi]ₜ and its precision matrix Lₜ. Specifically, the computation unit 130 updates i-vector [phi]ₜ and its precision matrix Lₜ using the i-vector [phi]ₜ₋₁ and its precision matrix Lₜ₋₁ estimated (computed) at previous time step t−1, and the observation oₜ and its alignment [gamma]_{C, t} at current time step t computed above.

The computation unit 130 updates the i-vector [phi]ₜ and its precision matrix Lₜ using Equation 6 and Equation 7 described below.

[Math. 4]

ϕₜ=Lₜ⁻¹[Σ_{c=1}^{C}γ_{c,t}T_{c}^{T}Σ_{c}⁻¹(oₜ−μ_{c})+Lₜ₋₁ϕₜ₋₁] (Equation 6)

Lₜ=[Σ_{c=1}^{C}γ_{c,t}T_{c}^{T}Σ_{c}⁻¹T_{c}+Lₜ₋₁] (Equation 7)

C, [omega]_{C}, [mu]_{C}, [Sigma]_{C}, and T_{C} are the same as the parameters described above. The observation (feature vector) oₜ and the number [tau] of feature vectors in the set are also the same as the contents described above. [phi]ₜ₋₁ represents the i-vector estimated at the previous time step t−1, and Lₜ₋₁ is the precision matrix of the i-vector estimated at the previous time t−1.

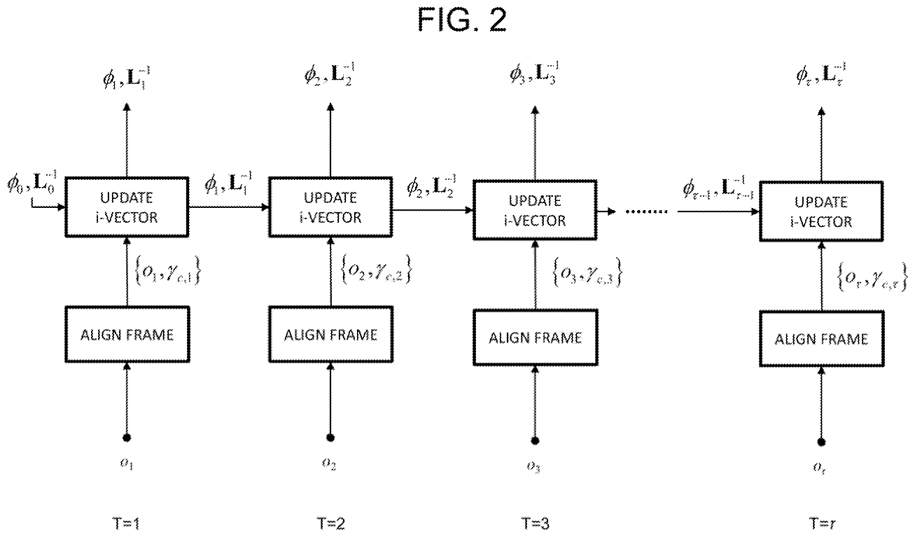

Thereafter, the input unit 120 and the computation unit 130 repeat the above processing each time step a new observation is received. FIG. 2 is an exemplary explanatory diagram illustrating the process of first exemplary embodiment of the speaker embedding apparatus 100 according to the present invention. First, at time step t=1, when the input unit 120 receives the observation o₁, the computation unit 130 computes a frame alignment [gamma]_{c, 1} based on the above-described parameters and an observation o₁. Then, the computation unit 130 updates the i-vector and the precision matrix. In the initial state, it is initialized as [phi]₀=0 and L₀=I, and the computation unit 130 updates i-vector [phi]₁ and its precision matrix L₁ by using {o₁, [gamma]_{c, 1}}, [phi]₀ and L₀.

Next, at time step t=2, when the input unit 120 receives the observation o₂, the computation unit 130 computes a frame alignment [gamma]_{c, 2} based on the above-described parameters and the observation o₂. Then, the computation unit 130 updates i-vector [phi]₂ and its precision matrix L₂ by using [phi]₁ and L₁ estimated at previous time step t=1, and {o₂, [gamma]_{c, 2}}. The same applies to time step t=3. Thereafter, each time step the input unit 120 receives an observation, the above process is recursively repeated.

That is, when the input unit 120 receives an observation o_{[tau]} at the current time step t=[tau], the computation unit 130 computes the frame alignment [gamma]_{c, [tau]} based on the above-described parameters and the observation o_{[tau]}. Then, the computation unit 130 updates the i-vector [phi]_{[tau]} and its precision matrix L_{[tau]} by using [phi]_{[tau]-1} and its precision matrix L_{[tau]-1} estimated at previous time step t=[tau]−1, and {o_{[tau]}, [gamma]_{c, [tau]}}.

The output unit 140 outputs the updated i-vector [phi]_{[tau]} and its precision matrix L_{[tau]}. The output unit 140 may output, for example, the i-vector [phi]_{[tau]} and its precision matrix L_{[tau]} to the recognition device 10. The recognition device 10 may perform recognition (verification) processing using the updated i-vector [phi]_{[tau]} and its precision matrix L_{[tau]}.

The input unit 120, the computation unit 130 and the output unit 140 are implemented by a CPU of a computer operating according to a program (speaker embedding program). For example, the program may be stored in the storage unit 110, with the CPU reading the program and, according to the program, operating as the input unit 120, the computation unit 130 and the output unit 140. The functions of the speaker embedding apparatus may be provided in the form of SaaS (Software as a Service).

The input unit 120, the computation unit 130 and the output unit 140 may each be implemented by dedicated hardware. All or part of the components of each device may be implemented by general-purpose or dedicated circuitry, processors, or combinations thereof. They may be configured with a single chip, or configured with a plurality of chips connected via a bus. All or part of the components of each device may be implemented by a combination of the above-mentioned circuitry or the like and program.

In the case where all or part of the components of each device is implemented by a plurality of information processing devices, circuitry, or the like, the plurality of information processing devices, circuitry, or the like may be centralized or distributed. For example, the information processing devices, circuitry, or the like may be implemented in a form in which they are connected via a communication network, such as a client-and-server system or a cloud computing system.

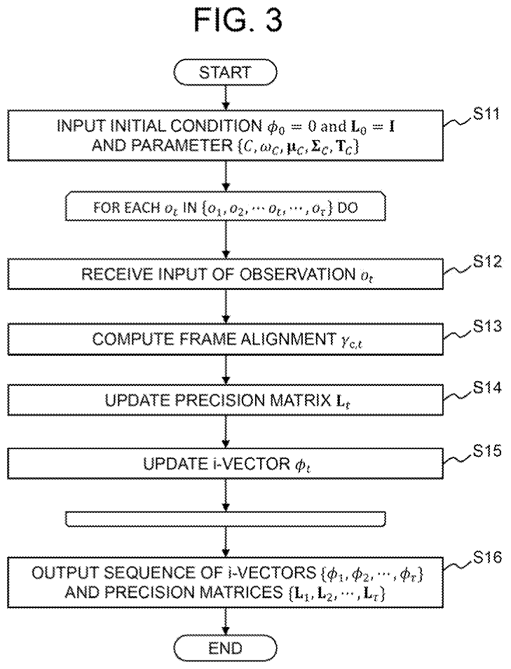

Next, an operation example of the speaker embedding apparatus 100 according to the present exemplary embodiment will be described. FIG. 3 is a flowchart illustrating the process of first exemplary embodiment of the speaker embedding apparatus 100 according to the present invention. First, the input unit 120 inputs initial conditions [phi]₀=0 and L₀=I, and parameters {C, [omega]_{C}, [mu]_{C}, [Sigma]_{C}, and T_{C}} (step S11). The initial conditions and parameters may be stored in advance in storage unit 110.

Subsequently, the processing from step S12 to step S15 is repeated for each observation oₜ which is element of {o₁, o₂, . . . , o_{[tau]}}. The input unit 120 receives an input of the observation oₜ (step S12). The computation unit 130 computes the frame alignment [gamma]_{c, t} by using the Equation 1 described above (step S13). Then, computation unit 130 updates the precision matrix from Lₜ₋₁ to Lₜ by using Equation 7 described above (step S14), and updates the i-vector from [phi]ₜ₋₁ to [phi]ₜ by using Equation 6 described above (step S15). The computation unit 130 may store the computed i-vector and precision matrix in the storage unit 110.

Then, the output unit 140 outputs the computed sequence of i-vectors {[phi]₁, [phi]₂, . . . , [phi]_{[tau]}} and their precision matrices {L₁, L₂, . . . , L_{[tau]}} (step S16).

Next, it will be described that the i-vector is appropriately updated by the speaker embedding apparatus 100 according to the present exemplary embodiment. The term Lₜ₋₁[phi]ₜ₋₁ included in the above Equation 6 can be expanded as the following Equation 8.

[Math. 5]

Lₜ₋₁Lₜ₋₁⁻¹(Σ_{c=1}^{C}γ_{c,t-1}T_{c}^{T}Σ_{c}⁻¹(oₜ₋₁−μ_{c})+Lₜ₋₂ϕₜ₋₂) (Equation 8)

Since Lₜ₋₁Lₜ₋₁⁻¹ becomes an identity matrix, the equation in parentheses remains. By repeating this process, Equation 9 described below can be derived.

$$\begin{matrix}[ Math . 6 ] & \\ \begin{matrix}{ϕ}_{t} = {L}_{t}^{- 1} [ {\sum }_{c = 1}^{C} {γ}_{c , t} {T}_{c}^{T} {Σ}_{c}^{- 1} ( {o}_{t} - {μ}_{c} ) + {L}_{t - 1} {ϕ}_{t - 1} ] \\ = {L}_{t}^{- 1} [ {\sum }_{c = 1}^{C} {γ}_{c , t} {T}_{c}^{T} {Σ}_{c}^{- 1} ( {o}_{t} - {μ}_{c} ) + \\ ( {\sum }_{c = 1}^{C} {γ}_{c , t - 1} {T}_{c}^{T} {Σ}_{c}^{- 1} ( {o}_{t - 1} - {μ}_{c} ) + {L}_{t - 2} {ϕ}_{t - 2} ) ] \\ = {L}_{t}^{- 1} [ {\sum }_{c = 1}^{C} {γ}_{c , t} {T}_{c}^{T} {Σ}_{c}^{- 1} ( {o}_{t} - {μ}_{c} ) + … + \\ {\sum }_{c = 1}^{C} {γ}_{c , l} {T}_{c}^{T} {Σ}_{c}^{- 1} ( {o}_{t - 1} - {μ}_{c} ) + {L}_{o} {ϕ}_{o} ] \\ = {L}_{t}^{- 1} [ {\sum }_{c = 1}^{C} {γ}_{c , t} {T}_{c}^{T} {Σ}_{c}^{- 1} ( {o}_{t} - {μ}_{c} ) + … + \\ {\sum }_{c = 1}^{C} {γ}_{c , l} {T}_{c}^{T} {Σ}_{c}^{- 1} ( {o}_{t - 1} - {μ}_{c} ) ] \\ = {L}_{t}^{- 1} [ {\sum }_{c = 1}^{C} {\sum }_{l = 1}^{t} {γ}_{c , l} {T}_{c}^{T} {Σ}_{c}^{- 1} ( {o}_{l} - {μ}_{c} ) ] \\ = {L}_{t}^{- 1} [ {\sum }_{c = 1}^{C} {T}_{c}^{T} {Σ}_{c}^{- 1} {\sum }_{l = 1}^{t} {γ}_{c , l} ( {o}_{l} - {μ}_{c} ) ]\end{matrix} & ( Equation 9 )\end{matrix}$$

The above Equation 9 is equal to the general offline computed i-vector described by the above Equation 4.

Similarly, the term Lₜ₋₁ included in the above Equation 7 can be expanded as the following Equation 10.

[Math. 7]

Σ_{c=1}^{C}γ_{c,t-1}T_{c}^{T}Σ_{c}⁻¹T_{c}+Lₜ₋₂ (Equation 10)

By repeating this expansion process, Equation 11 described below can be derived.

$$\begin{matrix}[ Math . 8 ] & \\ \begin{matrix}{L}_{t}^{- 1} = {[ {\sum }_{c = 1}^{C} {γ}_{c , t} {T}_{c}^{T} {Σ}_{c}^{- 1} {T}_{c} + {L}_{t - 1} ]}^{- 1} \\ = {[ {\sum }_{c = 1}^{C} {γ}_{c , t} {T}_{c}^{T} {Σ}_{c}^{- 1} {T}_{c} + {\sum }_{c = 1}^{C} {γ}_{c , t - 1} {T}_{c}^{T} {Σ}_{c}^{- 1} {T}_{c} + {L}_{- 2} ]}^{- 1} \\ = [ {\sum }_{c = 1}^{C} {γ}_{c , t} {T}_{c}^{T} {Σ}_{c}^{- 1} {T}_{c} + {\sum }_{c = 1}^{C} {γ}_{c , t - 1} {T}_{c}^{T} {Σ}_{c}^{- 1} {T}_{c} + … + \\ {{\sum }_{c = 1}^{C} {γ}_{c , l} {T}_{c}^{T} {Σ}_{c}^{- 1} {T}_{c} + {L}_{o} ]}^{- 1} \\ = [ {\sum }_{c = 1}^{C} {γ}_{c , t} {T}_{c}^{T} {Σ}_{c}^{- 1} {T}_{c} + {\sum }_{c = 1}^{C} {γ}_{c , t - 1} {T}_{c}^{T} {Σ}_{c}^{- 1} {T}_{c} + … + \\ {{\sum }_{c = 1}^{C} {γ}_{c , l} {T}_{c}^{T} {Σ}_{c}^{- 1} {T}_{c} + I ]}^{- 1} \\ = {[ {\sum }_{c = 1}^{C} {\sum }_{l = 1}^{t} {γ}_{c , l} {T}_{c}^{T} {Σ}_{c}^{- 1} {T}_{c} + I ]}^{- 1} \\ = {[ {\sum }_{c = 1}^{C} {N}_{c} {T}_{c}^{T} {Σ}_{c}^{- 1} {T}_{c} + I ]}^{- 1}\end{matrix} & ( Equation 11 )\end{matrix}$$

Equation 11 is equal to the general offline computed precision matrix described in Equation 5 above.

As described above, according to the present exemplary embodiment, the input unit 120 inputs the observation oₜ at current time step t, the computation unit 130 computes the frame alignment [gamma] at a current time step t by using the input observation oₜ. Furthermore, the computation unit 130 computes the i-vector and a precision matrix by using the computed frame alignment [gamma], the input observation oₜ, and a product obtained when computing the i-vector at the previous time step t−1, and the output unit outputs the computed i-vector and precision matrix. Specifically, the computation unit 130 updates the i-vector [phi]ₜ and the precision matrix Lₜ by using the i-vector [phi]ₜ₋₁ and its precision matrix Lₜ₋₁ at the previous time step t−1, the frame alignment [gamma] and the observation oₜ. Therefore, it is possible to realize speaker embedding in real time while reducing the storage capacity.

That is, in the present exemplary embodiment, the computation unit 130 updates the i-vector and the precision matrix without directly using past observations other than the observation oₜ at current time step t. In other words, to estimate the i-vector [phi]ₜ and its precision matrix L^{t} at the current time step t, only the feature vector oₜ at the current time step t, and the i-vector [phi]ₜ₋₁ and its covariance matrix Lₜ⁻¹ at the previous time step t−1 are required. Therefore, there is no need to store past raw features, and the storage capacity can be reduced.

### Second Exemplary Embodiment

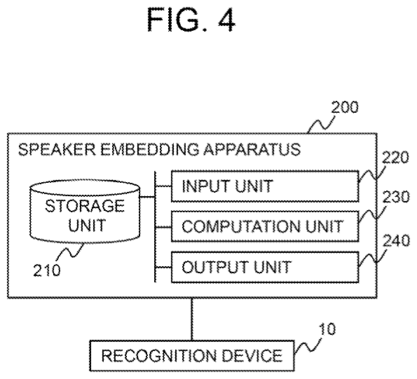

In the second exemplary embodiment, a method of performing speaker embedding by recursively updating an intermediate representation will be described. FIG. 4 depicts an exemplary block diagram illustrating the structure of a second exemplary embodiment of a speaker embedding apparatus according to the present invention. The speaker embedding apparatus 200 according to the present exemplary embodiment includes a storage unit 210, an input unit 220, a computation unit 230 and an output unit 240.

The speaker embedding apparatus 200 is also connected to the recognition device 10, and the recognition device 10 performs speaker recognition (verification) using the processing result by the speaker embedding apparatus 200. Therefore, a system including the speaker embedding apparatus 200 of the present exemplary embodiment and the recognition unit 10 can be referred to as a speaker recognition system (speaker verification system).

The storage unit 210 stores the computation result by the computation unit 230 described later. In addition, the storage unit 210 may store observations input by the input unit 220 described later. Note that the speaker embedding apparatus 200 according to the present exemplary embodiment also updates the i-vector at the current time step using the products obtained at the time step of computation of the previous i-vector. Therefore, the speaker embedding apparatus 200 does not have to store all the past observations. The storage unit 210 also stores various parameters used for computation by the computation unit 230 described later. The storage unit 210 is realized by, for example, a magnetic disk or the like.

The input unit 220 receives an input of observations used by the computation unit 230 described later for updating the i-vector. Specifically, the input unit 220 receives the observations oₜ at the current time step t. The input unit 220 may also receive input of various parameters used for computation by the computation unit 230 described later.

The computation unit 230 updates the i-vector using the observation oₜ at the current time step t and the products obtained at the time step of computation of the i-vector at the previous time step t−1. In this exemplary embodiment, the computation unit 230 uses the observation oₜ at the current time step t and a zero-order statistics and a first-order statistics at the previous time step t−1 to compute the i-vector [phi]ₜ and precision matrix Lₜ.

Specifically, first, the computation unit 230 computes an alignment [gamma]_{C, t} of the feature vector oₜ to each of the C Gaussian components by the Equation 1 described above, similarly to the computation unit 130 of the first exemplary embodiment.

Next, the computation unit 230 computes the zero-order statistics and the first-order statistics. Specifically, the computation unit 230 updates the zero-order statistics and the first-order statistics using the zero-order statistics and the first-order statistics estimated (computed) at previous time step t−1, and the observation oₜ and its alignment [gamma]_{C, t} at current time step t computed above.

The computation unit 230 updates the zero-order statistics N_{C}(t) and the first-order statistics F_{C}(t) using Equation 12 and Equation 13 described below.

[Math. 9]

N_{c}(t)=N_{c}(t−1)+γ_{c,t} (Equation 12)

F_{c}(t)=F_{c}(t−1)+γ_{c,t}(oₜ−μ_{c}) (Equation 13)

Then, the computation unit 230 infers the i-vector [phi]t and its precision matrix Lₜ using the updated zero-order statistics and first-order statistics. The computation unit 230 may estimate the i-vector [phi]ₜ and its precision matrix Lₜ using Equation 4 and Equation 5 described above.

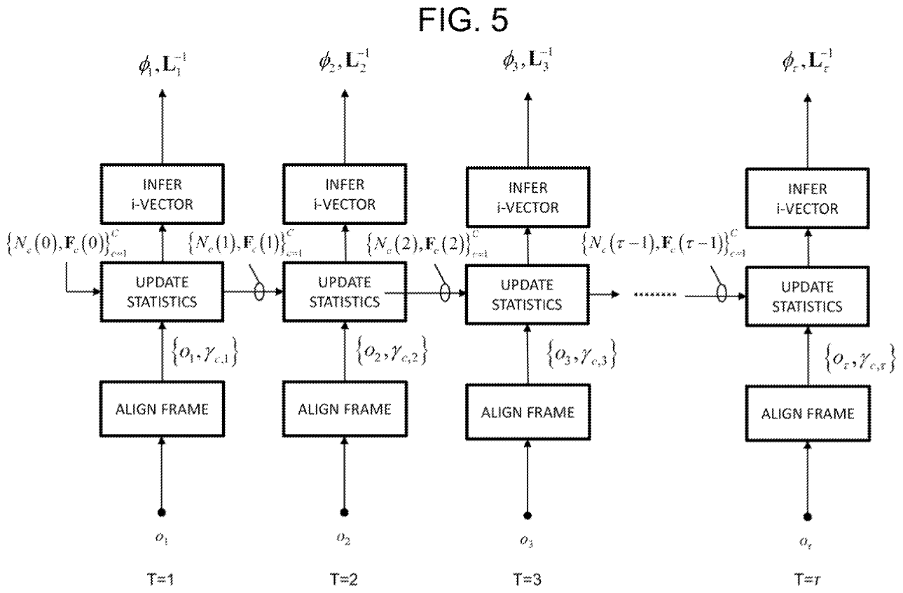

Thereafter, the input unit 220 and the computation unit 230 repeat the above processing each time step a new observation is received. FIG. 5 is an exemplary explanatory diagram illustrating the process of second exemplary embodiment of the speaker embedding apparatus 200 according to the present invention. First, at time step t=1, when the input unit 220 receives the observation o₁, the computation unit 230 computes a frame alignment [gamma]_{c, 1} based on the above-described parameters and an observation o₁. Then, the computation unit 230 updates the zero-order statistics and the first-order statistics. In the initial state, it is initialized as N_{C}(0)=0 and F_{C}(0)=I for each C, and the computation unit 230 updates the zero-order statistics N_{C}(1) and the first-order statistics F_{C}(1) by using {o₁, [gamma]_{c, 1}}, N_{C}(0) and F_{C}(0).

Then, the computation 230 infers the i-vector [phi]₁ and its precision matrix L₁ by using the updated zero-order statistic N_{C}(1) and the first-order statistic F_{C}(1).

Next, at time step t=2, when the input unit 220 receives the observation o₂, the computation unit 230 computes a frame alignment [gamma]_{c, 2} based on the above-described parameters and the observation o₂. The computation unit 230 updates the zero-order statistics N_{C}(2) and the first-order statistics F_{C}(2) by using zero-order statistics N_{C}(1) and the first-order statistics F_{C}(1) updated at previous time step t=1, and {o₂, [gamma]_{c, 2}}. Then, the computation 230 infers the i-vector [phi]₂ and its precision matrix L₂ by using the updated zero-order statistic N_{C} (2) and the first-order statistic F_{C} (2). The same applies to time step t=3. Thereafter, each time step the input unit 220 receives an observation, the above process is recursively repeated.

That is, when the input unit 220 receives an observation o_{[tau]} at the current time step t=[tau], the computation unit 230 computes the frame alignment [gamma]_{c, [tau]} based on the above-described parameters and the observation o_{[tau]}. The computation unit 230 updates the zero-order statistics N_{C}([tau]) and the first-order statistics F_{C}([tau]) by using zero-order statistics N_{C}([tau]−1) and the first-order statistics F_{C}([tau]−1) updated at previous time step t=[tau]−1, and {o_{[tau]}, [gamma]_{c, [tau]}}. Then, the computation 230 infers the i-vector [phi]_{[tau]} and its precision matrix L_{[tau]} by using the updated zero-order statistic N_{C} ([tau]) and first-order statistic F_{C} ([tau]).

The output unit 240 outputs the updated i-vector [phi]_{[tau]} and its precision matrix L_{[tau]}. The output unit 240 may output, as in the first exemplary embodiment, the i-vector [phi]_{[tau]} and its precision matrix L_{[tau]}⁻¹ to the recognition device 10. The recognition device 10 may perform recognition (verification) processing using the updated i-vector [phi]_{[tau]} and its precision matrix L_{[tau]}.

The input unit 220, the computation unit 230 and the output unit 240 are implemented by a CPU of a computer operating according to a program (speaker embedding program).

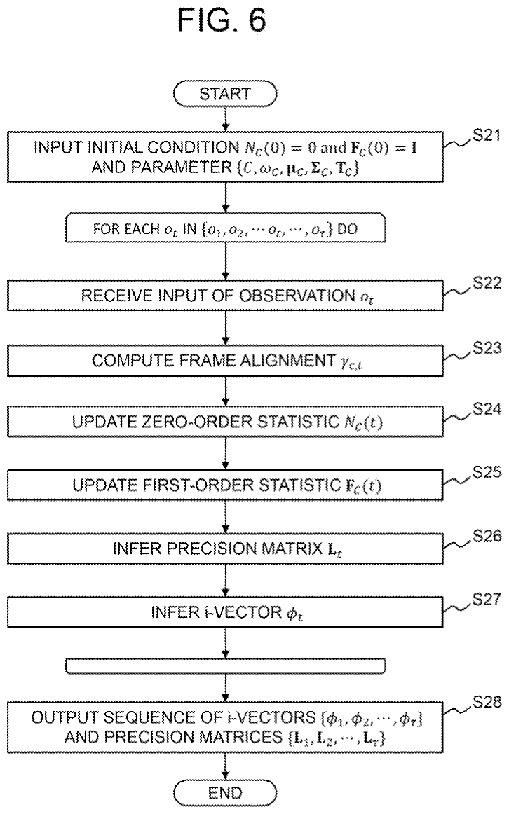

Next, an operation example of the speaker embedding apparatus 200 according to the present exemplary embodiment will be described. FIG. 6 is a flowchart illustrating the process of second exemplary embodiment of the speaker embedding apparatus 200 according to the present invention. First, the input unit 220 inputs initial conditions N_{C}(0)=0 and F_{C}(0)=I, and parameters {C, [omega]_{C}, [mu]_{C}, [Sigma]_{C}, and T_{C}} (step S21). The initial conditions and parameters may be stored in advance in storage unit 210.

Subsequently, the processing from step S22 to step S27 is repeated for each observation oₜ which is element of {o₁, o₂, . . . , o_{[tau]}}. The input unit 220 receives an input of the observation oₜ (step S22). The computation unit 230 computes the frame alignment [gamma]_{c, t} by using the Equation 1 described above (step S23). Then, computation unit 230 updates the zero-order statistic N_{C} (t−1) to N_{C} (t) by using Equation 12 described above (step S24), and updates the first-order statistic F_{C}(t−1) to F_{C}(t) by using Equation 13 described above (step S25).

The computation unit 230 infers the precision matrix Lₜ using Equation 5 described above (step S26), and infers the i-vector [phi]ₜ using Equation 4 described above (step S27). The computation unit 230 may store the computed i-vector and precision matrix in the storage unit 210.

Then, the output unit 240 outputs the inferred sequence of i-vectors {[phi]₂, [phi]₁, [phi]₂, . . . , [phi]_{[tau]}} and their precision matrices {L₁, L₂, . . . , L_{[tau]}} (step S28).

Next, it will be described that the i-vector is appropriately inferred by the speaker embedding apparatus 200 according to the present exemplary embodiment. The above Equation 2 can be expanded as the following Equation 14.

[Math. 10]

N_{c}=Σₜ₌₁^{τ-1}γ_{c,t}+γ_{c,τ} (Equation 14)

The first term corresponds to the zero-order statistic at t=[tau]−1 and the second term can be calculated from the observation oₜ at t=[tau].

Similarly, the above Equation 3 can be expanded as the following Equation 15.

[Math. 11]

F_{C}=Σₜ₌₁^{τ-1}γ_{c,t}(oₜ−μ_{C})+γ_{C,τ}(o_{τ}−μ_{C}) (Equation 15)

The first term corresponds to the first-order statistic at t=[tau]−1 and the second term can be calculated from the observation oₜ at t=[tau].

Therefore, Equations 14 and 15 become equal to the general offline computed zero-order statistics and first-order statistics described in Equations 2 and 3 respectively.

As described above, according to the present exemplary embodiment, the computation unit 230 updates the i-vector [phi]ₜ and the precision matrix Lₜ by using the zero-order statistics and first-order statistics at the previous time step t−1, the frame alignment [gamma] and the observation oₜ. Therefore, as in the first exemplary embodiment, it is possible to realize speaker embedding in real time while reducing the storage capacity.

That is, in the present exemplary embodiment, the computation unit 230 also updates the i-vector and the precision matrix without directly using past observations other than the observation oₜ at current time step t. In other words, to estimate the i-vector [phi]ₜ and its precision matrix L^{t} at the current time step t, only the feature vector oₜ at the current time step t, and the zero-order statistics and the first-order statistics at the previous time step t−1 are required. Therefore, there is no need to store past raw features, and the storage capacity can be reduced.

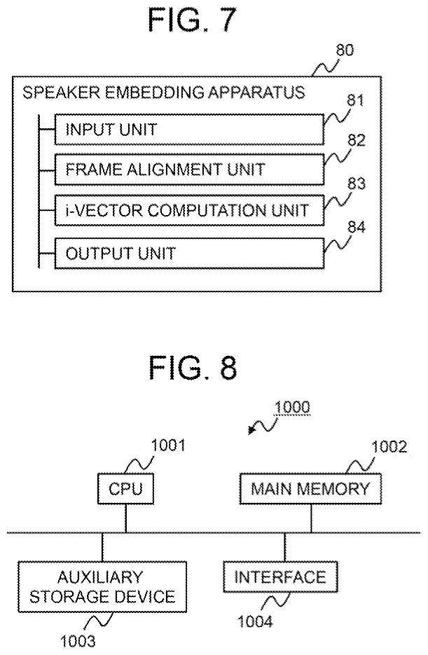

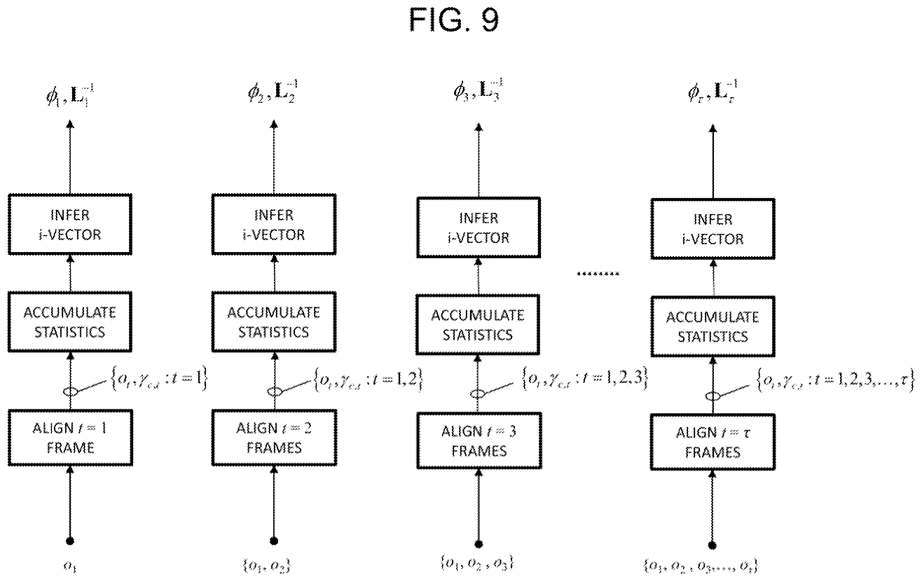

Next, an outline of the present invention will be described. FIG. 7 depicts a block diagram illustrating an outline of the speaker embedding apparatus according to the present invention. The speaker embedding apparatus 80 (for example, speaker embedding apparatus 100, 200) using an i-vector, the speaker embedding apparatus including: an input unit 81 (for example, the input unit 120, 220) which inputs an observation (for example, observation oₜ) at current time step (for example, time step t); a frame alignment unit 82 (for example, the computation unit 130, 230) which computes a frame alignment (for example, frame alignment [gamma]) at a current time step by using the input observation; an i-vector computation unit 83 (for example, the computation unit 130, 230) which computes an i-vector (for example, i-vector [phi]) and a precision matrix (for example, L) by using the computed frame alignment, the input observation, and a product (for example, i-vector, precision matrix, zero-order statistics, and first-order statistics) obtained when computing the i-vector at the previous time step (for example, time step t−1); and an output unit 84 (for example, the output unit 140, 240) which outputs the computed i-vector and precision matrix.

With such a configuration, it is possible to realize speaker embedding in real time while reducing the storage capacity.

At that time, the i-vector computation unit 83 may update the i-vector and the precision matrix by using the i-vector (for example, i-vector [phi]ₜ₋₁) and its precision matrix (for example, precision matrix Lₜ₋₁) at the previous time step (for example, time step t−1), the frame alignment and the observation.

Also, the i-vector computation unit 83 may update the i-vector and the precision matrix by using zero-order statistics (for example, N_{C}(t)) and first-order statistics (for example, F_{C}(t)) at the previous time step (for example, time step t−1), the frame alignment and the observation.

Specifically, the i-vector computation unit 83 may update the i-vector and the precision matrix without directly using past observations other than the observation at current time step.

Also, the i-vector computation unit 83 may compute the i-vector and the precision matrix by recursively updating the product obtained at the time step of computation of the i-vector at previous time step.

FIG. 8 depicts a schematic block diagram illustrating a configuration of a computer according to at least one of the exemplary embodiments. A computer 1000 includes a CPU 1001, a main storage device 1002, an auxiliary storage device 1003, and an interface 1004.

Each of the above-described speaker embedding apparatus is mounted on the computer 1000. The operation of the respective processing units described above is stored in the auxiliary storage device 1003 in the form of a program (a speaker embedding program). The CPU 1001 reads the program from the auxiliary storage device 1003, deploys the program in the main storage device 1002, and executes the above processing according to the program.

Note that at least in one of the exemplary embodiments, the auxiliary storage device 1003 is an exemplary non-transitory physical medium. Other examples of non-transitory physical medium include a magnetic disc, a magneto-optical disk, a CD-ROM, a DVD-ROM, and a semiconductor memory that are connected via the interface 1004. In the case where the program is distributed to the computer 1000 by a communication line, the computer 1000 distributed with the program may deploy the program in the main storage device 1002 to execute the processing described above.

Incidentally, the program may implement a part of the functions described above. The program may implement the aforementioned functions in combination with another program stored in the auxiliary storage device 1003 in advance, that is, the program may be a differential file (differential program).

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

The whole or part of the example embodiments disclosed above can be described as, but not limited to, the following supplementary notes.

(Supplementary note 1) A speaker embedding apparatus using an i-vector comprising: an input unit which inputs an observation at current time step; a frame alignment unit which computes a frame alignment at a current time step by using the input observation; an i-vector computation unit which computes an i-vector and a precision matrix by using the computed frame alignment, the input observation, and a product obtained when computing the i-vector at the previous time step; and an output unit which outputs the computed i-vector and precision matrix.

(Supplementary note 2) The speaker embedding apparatus according to supplementary note 1, wherein, the i-vector computation unit updates the i-vector and the precision matrix by using the i-vector and its precision matrix at the previous time step, the frame alignment and the observation.

(Supplementary note 3) The speaker embedding apparatus according to supplementary note 1, wherein, the i-vector computation unit updates the i-vector and the precision matrix by using zero-order statistics and first-order statistics at the previous time step, the frame alignment and the observation.

(Supplementary note 4) The speaker embedding apparatus according to any one of supplementary notes 1 to 3, wherein, the i-vector computation unit updates the i-vector and the precision matrix without directly using past observations other than the observation at current time step.

(Supplementary note 5) The speaker embedding apparatus according to any one of supplementary notes 1 to 4, wherein, the i-vector computation unit computes the i-vector and the precision matrix by recursively updating the product obtained at the time step of computation of the i-vector at previous time step.

(Supplementary note 6) A speaker embedding method using an i-vector comprising: inputting an observation at current time step; computing a frame alignment at a current time step by using the input observation; computing an i-vector and a precision matrix by using the computed frame alignment, the input observation, and a product obtained when computing the i-vector at the previous time step; and outputting the computed i-vector and precision matrix.

(Supplementary note 7) The speaker embedding method according to supplementary note 6, wherein the i-vector and the precision matrix are updated by using the i-vector and its precision matrix at the previous time step, the frame alignment and the observation.

(Supplementary note 8) The speaker embedding method according to supplementary note 6, wherein the i-vector and the precision matrix are updated by using zero-order statistics and first-order statistics at the previous time step, the frame alignment and the observation.

(Supplementary note 9) A non-transitory computer readable recording medium storing a speaker embedding program using an i-vector, when executed by a processor, that performs a method for: inputting an observation at current time step; computing a frame alignment at a current time step by using the input observation; computing an i-vector and a precision matrix by using the computed frame alignment, the input observation, and a product obtained when computing the i-vector at the previous time step; and outputting the computed i-vector and precision matrix.

(Supplementary note 10) The non-transitory computer readable recording medium according to supplementary note 9, wherein the i-vector and the precision matrix are updated by using the i-vector and its precision matrix at the previous time step, the frame alignment and the observation.

(Supplementary note 11) The non-transitory computer readable recording medium according to supplementary note 9, wherein the i-vector and the precision matrix are updated by using zero-order statistics and first-order statistics at the previous time step, the frame alignment and the observation.

What is claimed is:

1. A speaker embedding apparatus using an i-vector comprising:
a memory storing instructions; and
one or more processors configured to execute the instructions to:
input an observation at a current time step;
compute a frame alignment at the current time step by using the input observation;
compute an i-vector and a precision matrix by using the computed frame alignment, the input observation, and a product obtained when computing an i-vector at a previous time step; and
output the computed i-vector and the precision matrix.

2. The speaker embedding apparatus according to claim 1, wherein the processor further executes instructions to
update the i-vector and the precision matrix by using the i-vector and its precision matrix at the previous time step, the frame alignment, and the observation.

3. The speaker embedding apparatus according to claim 1, wherein the processor further executes instructions to
wherein, the i-vector computation unit updates update the i-vector and the precision matrix by using zero-order statistics and first-order statistics at the previous time step, the frame alignment, and the observation.

4. The speaker embedding apparatus according to claim 1, wherein the processor further executes instructions to
update the i-vector and the precision matrix without directly using past observations other than the observation at current time step.

5. The speaker embedding apparatus according to claim 1, wherein the processor further executes instructions to
compute the i-vector and the precision matrix by recursively updating the product obtained at the time step of computation of the i-vector at the previous time step.

6. A speaker embedding method using an i-vector comprising:
inputting an observation at a current time step;
computing a frame alignment at the current time step by using the input observation;
computing an i-vector and a precision matrix by using the computed frame alignment, the input observation, and a product obtained when computing an i-vector at a previous time step; and
outputting the computed i-vector and the precision matrix.

7. The speaker embedding method according to claim 6, wherein the i-vector and the precision matrix are updated by using the i-vector and its precision matrix at the previous time step, the frame alignment, and the observation.

8. The speaker embedding method according to claim 6, wherein the i-vector and the precision matrix are updated by using zero-order statistics and first-order statistics at the previous time step, the frame alignment, and the observation.

9. A non-transitory computer readable recording medium storing a speaker embedding program using an i-vector, when executed by a processor, that performs a method for:
inputting an observation at a current time step;
computing a frame alignment at the current time step by using the input observation;
computing an i-vector and a precision matrix by using the computed frame alignment, the input observation, and a product obtained when computing an i-vector at a previous time step; and
outputting the computed i-vector and the precision matrix.

10. The non-transitory computer readable recording medium according to claim 9, wherein the i-vector and the precision matrix are updated by using the i-vector and its precision matrix at the previous time step, the frame alignment, and the observation.

11. The non-transitory computer readable recording medium according to claim 9, wherein the i-vector and the precision matrix are updated by using zero-order statistics and first-order statistics at the previous time step, the frame alignment, and the observation.
